(19) United States
(12) Patent Application Publication
(10) Pub. No.: US 2009/0132407 A1
(43) Pub. Date: May 21, 2009

(54) Mobile banking vehicle

(75) Inventor: Edward J. Romary, Fort Wayne, IN (US)

Correspondence Address: George Pappas, 919 S. Harrison Street, Suite 300, Fort Wayne, IN, 46802, US

(73) Assignee: Romary Associates, Inc.

(21) Appl. No.: 12/319,791

(22) Filed: Jan. 12, 2009

Related U.S. Application Data
(63) Continuation-in-part of application No. 11/352,040, filed on Feb. 10, 2006, now Pat. No. 7,475,809.

(51) Int. Cl. G06Q 40/00; B60P 3/025

(52) U.S. Cl. 705/35; 296/24.39

(57) ABSTRACT

A mobile banking vehicle that includes an enclosure having a floor, walls and a roof. A door is provided in one of the walls and wheels provide support and mobility to the enclosure. The vehicle includes a conveyance system wherein financial documents are selectively conveyable between first and second ports of the conveyance system. The first port is accessible from within the enclosure and the second port is accessible from a position exterior to and spaced from the enclosure. The conveyance system may take the form of a pneumatically powered conveyance system. Also disclosed is a method that includes moving a mobile banking vehicle having an enclosure from a first to a second location, conveying a financial document between a customer in a second vehicle outside the enclosure and a teller located within the enclosure and conducting a banking transaction associated with the financial document.

### CROSS REFERENCE TO RELATED APPLICATIONS

This is a continuation-in-part of application Ser. No. 11/352,040 filed Feb. 10, 2006 now U.S. Pat. No. 7,475,809.

### BACKGROUND OF THE INVENTION

1. Field of the Invention

The present invention related to mobile bank vehicles and, more particularly, relates to a self powered self contained mobile bank vehicle functioning in substantially all respects similar to a regular fixed banking building and including, among other capabilities, drive up lane and teller window, lobby, automated teller machine (ATM), and security features.

2. Description of Related Art

Banks and fixed bank buildings or structures have been in use for centuries. For decades, fixed bank structures have been equipped with drive-up teller windows and transaction drawers whereby customers can drive their vehicle in close proximity thereto, speak to a teller who is visible through the window and conduct their banking business by passing or moving their financial documents through the transaction drawer. The teller window is typically equipped with bullet resistant glass. The transaction drawer can be a more simple opening below the lowermost edge of the window glass wherethrough financial documents can be passed, or a more secure sliding drawer having a drawer door which is coupled to and adapted to open and close with the drawer for providing access to the drawer by only one of the teller or customer at any time. An intercommunication system is typically also provided for verbal communication between the teller and banking customer.

More recently, mobile banking vehicles have been devised for selectively bringing the bank to the customer. Large tractor trailers have been modified to include an office area accessible by steps and a door and wherein the office area includes a lobby and teller area adjacent one another, an administration area, a conference room and a private office. Small trucks have also been equipped as mobile banking vehicles by providing a teller window on a side wall thereof, whereby customers can walk up to the vehicle and conduct their banking business therethrough. Similarly, trailers and engine driven vehicles not having an office area therewithin have been equipped with ATM's on their side wall, whereby banking customers can walk up and use the ATM.

Of the existing mobile banking vehicles which are equipped with office areas for banking personnel and/or customers, steps are required between the ground surface and the higher floor of the office area. This is because the floor of the office area must be supported by and set on the chassis of the vehicle, and the chassis is supported by the vehicle wheels, axles and suspension system. The office area floor height also dictates the location of any windows relative to the ground surface and, placement of windows at a proper useable height relative to the office area floor places the window at an unusable or improper height for those on the ground surface outside of the office area. Currently, therefore, banking vehicles equipped with teller windows place such windows at a compromised height which is relatively low with respect to the office area floor height and relatively high with respect to the ground surface, but which thereby places such window at a height allowing customer walk-up transactions therethrough. Unfortunately, bank personnel are uncomfortable when working through such teller window because they must sit and work generally downwardly. Such compromised teller window locations are also relatively high with respect to the ground surface and are, hence, limited to substantially only customer walk-up transactions.

### SUMMARY OF THE INVENTION

Having first recognized the limitations and shortcomings of prior mobile banking vehicles, a need has been perceived and, hence, the object of the present invention is to overcome such limitations and shortcomings of prior banking vehicles and, more particularly, for a mobile banking vehicle which is provided with a teller window at a comfortable and proper height for use by both the banking personnel inside the banking vehicle and the customer outside of the banking vehicle.

Another object of the present invention is to provide a transaction drawer adjacent the teller window which is also at comfortable and proper height for use by both the banking personnel inside the banking vehicle and the customer outside of the banking vehicle.

Yet another object of the present invention is to provide the teller window and transaction drawer at a comfortable and proper height for use by the banking personnel and which may comfortably be used by customers for both walk-up and drive-up banking transactions.

Yet another object of the present invention is to provide a mobile bank vehicle which can function substantially similar in all respects to a regular fixed banking building and including, among other capabilities, a drive-up lane and teller window and transaction drawer for use by walk-up and/or drive-up customers, lobby, automated teller machine (ATM), and security features.

These and other objects of the present invention are achieved by providing a mobile banking vehicle having an enclosed office area defined by a floor, exterior walls and roof. The enclosed office area is accessible by bank personnel and customers via a door through the exterior wall. The office area is supported on a truck chassis placing the office area floor higher than the ground surface. Selectively retractable steps are provided adjacent the door between the ground surface and the higher office area floor height. The chassis is preferably supported at its front end with front wheels adapted for steering the vehicle, and rear wheels at the rear end thereof. The banking vehicle is preferably provided with an engine for selective engaging and driving the wheels and transport of the vehicle.

The office area floor is provided with a lowered area which is at a height lower than the other floor height and which is substantially closer to the ground surface. Steps are provided between the higher and lower floor areas for use by banking personnel. A teller window is located through an exterior wall adjacent the lowered floor area at a height which is comfortable and proper for use in both drive-up and walk-up customer banking transactions, and which is comfortable for use by banking personnel within the office area enclosure. Preferably the teller window is provided with bullet resistant glass and includes a bottom edge located about 35-57 inches, and most preferably about 37-41 inches, from a ground surface.

A transaction drawer is also provided through the exterior wall adjacent the lowered floor area and adjacent or, more preferably, below the teller window, whereby financial documents may be selectively moved between the inside and the outside of the enclosure. Preferably, the transaction drawer includes a bottom drawer surface located about 25-52, and most preferably about 25-29, inches from a ground surface. The transaction drawer can be an opening below the lowermost edge of the teller window glass wherethrough financial documents can be passed, or a sliding drawer having a drawer door which is coupled to and adapted to open and close with the drawer for providing access to the drawer by only one of the bank teller or customer at any time.

Preferably, an intercommunication system is provided whereby verbal communication is selectively provided between the bank teller inside the enclosure and the customer outside of the enclosure adjacent the teller window. The intercommunication system may include a plurality of slot openings through the teller window glass for providing verbal communication between the inside and the outside of the enclosure, or can be electronic including electronic microphones and speakers.

The mobile banking vehicle further preferably includes a customer vehicle drive up lane or area outside of the enclosure and adjacent the teller window. For drive-up banking transactions, to prevent the drive-up banking customer's vehicle from hitting the banking vehicle and helping such customer locate his vehicle at a proper distance from the banking vehicle, a bumper is provided on the banking vehicle exterior wall substantially below the teller window. The bumper can be fixed to and extending at least eight inches away from the exterior wall, or can be selectively extendable and retractable, whereby it can be extended when the teller window is being used and retracted when the teller window is not in use, such as when the banking vehicle is being transported to another location.

The mobile banking vehicle further preferably includes a canopy selectively extendable from the exterior wall adjacent the lowered floor area and substantially over the teller window and transaction drawer.

In one form thereof, the present invention is directed toward a mobile banking vehicle positionable on a ground surface. The vehicle includes an enclosure having a floor, walls and a roof. A door in one of the walls provides ingress and egress to the enclosure for personnel and wheels provide support and mobility to the enclosure. The vehicle also includes a conveyance system having a first port and a second port. The conveyance system has an operable configuration wherein financial documents are selectively conveyable between the first and second ports with the first port being accessible from within the enclosure and the second port being accessible from a position exterior to and spaced from the enclosure.

In another form thereof, the present invention is directed to a mobile banking vehicle positionable on a ground surface. The vehicle includes an enclosure having a floor, walls and a roof. A door in one of the walls provides ingress and egress to the enclosure for personnel and wheels support and provide mobility to the enclosure. The vehicle also includes first and second conveyance systems. The first conveyance system has a first port and a repositionable second port wherein financial documents are selectively conveyable between the first and second ports when the first conveyance system is in a deployed configuration. The first port is accessible from within the enclosure. When the first conveyance system is in a deployed configuration, the second port is accessible from a position exterior to and spaced from said enclosure. The second conveyance system has a third port and a fourth port wherein financial documents are selectively conveyable between the third and fourth ports with the third port being accessible from within the enclosure and the fourth port being accessible from outside the enclosure.

In yet another form thereof, the present invention is directed to a method of conducting a banking transaction. The method includes providing a mobile banking vehicle having an enclosure; moving the mobile banking vehicle from a first location to a second location; conveying a financial document between a customer located at the second location in a second vehicle outside the enclosure and a teller located within the enclosure; and conducting a banking transaction associated with the financial document.

### BRIEF DESCRIPTION OF THE DRAWINGS

The above-mentioned and other features and objects of this invention and the manner of obtaining them will become more apparent and the invention itself will be better understood by reference to the following description of embodiments of the invention taken in conjunction with the accompanying drawings wherein:

FIG. 1 is a side elevation view of a mobile banking vehicle constructed in accordance to the principles of the present invention;

FIG. 2 is an elevation view of the opposite side of the mobile banking vehicle shown in FIG. 1;

FIG. 3 is perspective view of the rear, side and roof of the mobile banking vehicle shown in FIG. 1;

FIG. 4 is a plan view of the mobile banking vehicle shown in FIG. 1 with the roof removed and showing the interior layout;

FIG. 5 is a plan view similar to FIG. 4, but depicting a different interior layout;

FIG. 6 is a side elevation view of the mobile banking vehicle shown in FIG. 4 with the side wall removed and showing the interior layout;

FIG. 7 is an elevation of the mobile banking vehicle shown in FIG. 4 with the side wall removed and showing the interior layout view opposite that shown in FIG. 6;

FIG. 8 is a partial side elevation view of the mobile banking vehicle shown in FIGS. 1-3 with the side wall exterior surface removed and showing the chassis and framing thereof;

FIG. 9 is a side elevation diagrammatic view of a mobile banking vehicle in accordance with the principles of the present invention and depicting the chassis and lowered teller floor area;

FIG. 10 is a side view of a mobile banking vehicle having a repositionable pneumatic conveyance system;

FIG. 11 is a partial side view of the mobile banking vehicle of FIG. 10 with the pneumatic conveyance system in an early stage of deployment;

FIG. 12 is a partial side view of the mobile banking vehicle of FIG. 10 with the pneumatic conveyance system in a later stage of deployment;

FIG. 13 is a side view of the mobile banking vehicle of FIG. 10 with the pneumatic conveyance system in a deployed configuration;

FIG. 14 is a plan view of the mobile banking vehicle of FIG. 10 with the pneumatic conveyance system in a deployed configuration;

FIG. 15 is an end schematic view of the pneumatic conveyance system in a deployed configuration;

FIG. 16 is a top schematic view of the canopy and pneumatic conveyance system in a deployed configuration; and

FIG. 17 is an interior elevation illustrating an interior port of the pneumatic conveyance system.

Corresponding reference characters indicate corresponding parts throughout the several views of the drawings.

The exemplifications set out herein illustrate preferred embodiments of the invention in one form thereof and such exemplifications are not to be construed as limiting the scope of the disclosure or the scope of the invention in any manner.

### DETAILED DESCRIPTION OF THE PREFERRED EMBODIMENT

A mobile banking vehicle constructed in accordance with the principles of the present invention is shown and depicted in the drawings by the numeral 10. Mobile banking vehicle 10 includes front wheels 12 near the front end 14 of vehicle 10 and rear wheels 16 near the rear end 18 of vehicle 10. Front wheels 12 are adapted for steering the vehicle 10 in a known and customary manner. An engine (not shown) is provided at the front end 14 under the engine compartment 20 and is selectively engaged to the rear wheels 16 with a transmission system (not shown) in a known and customary manner for driving the wheels 16 and transport of the mobile vehicle 10.

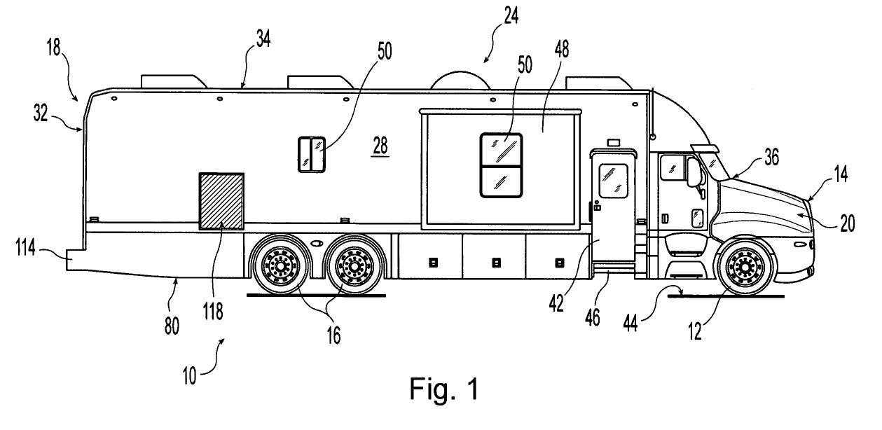

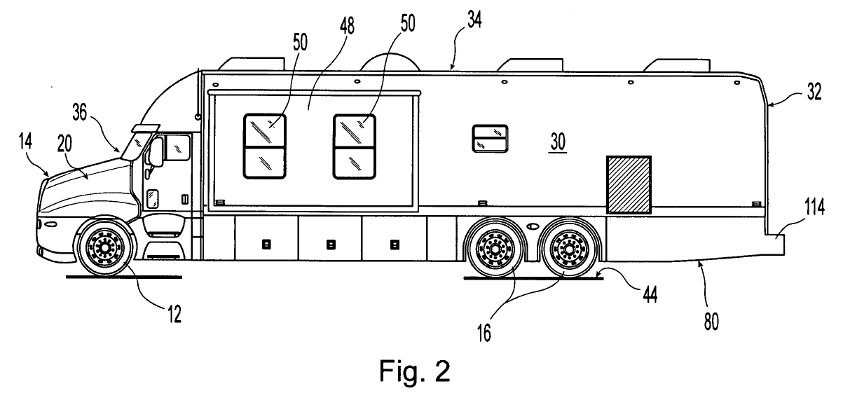

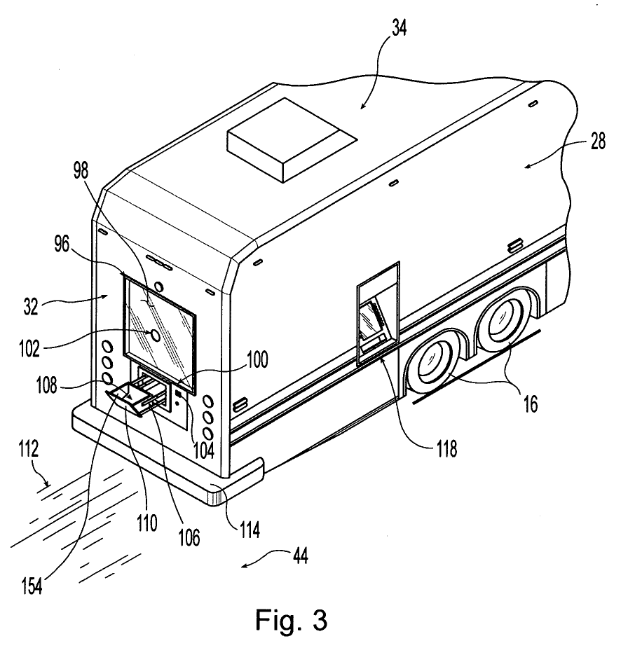

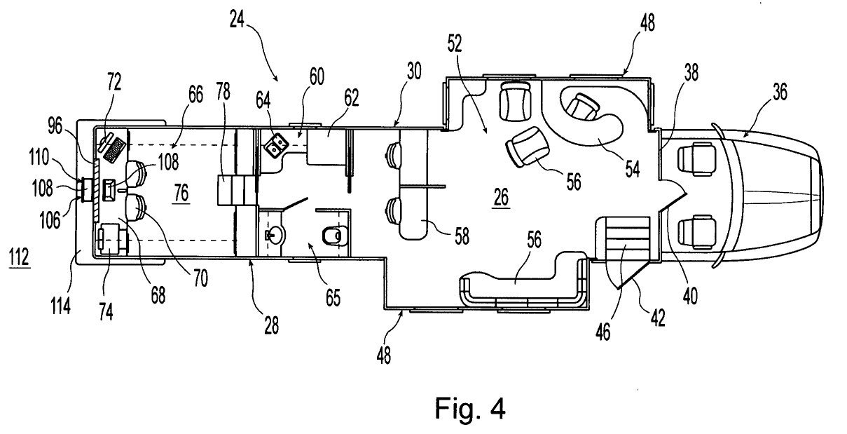

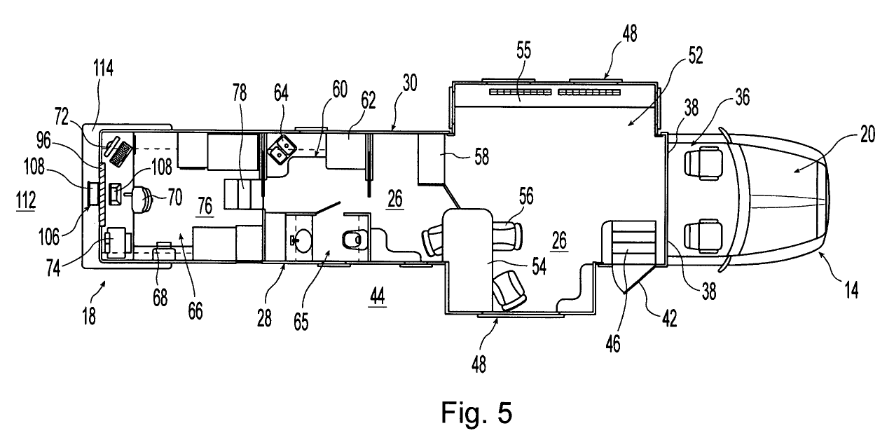

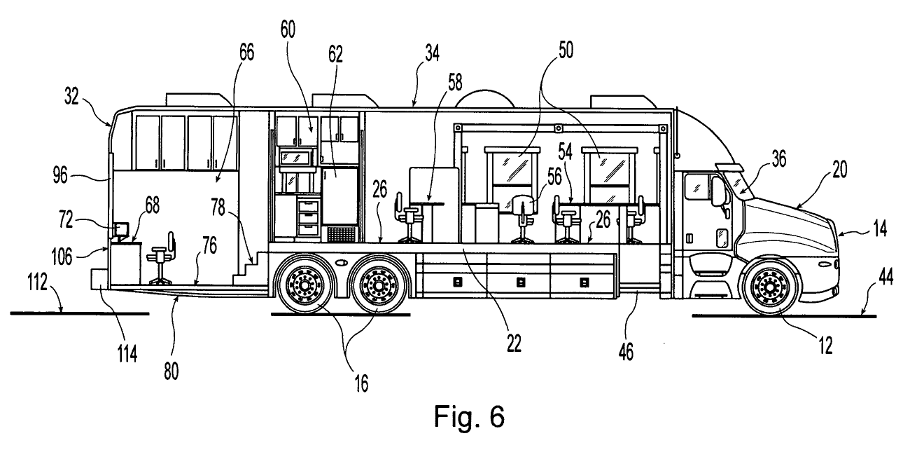

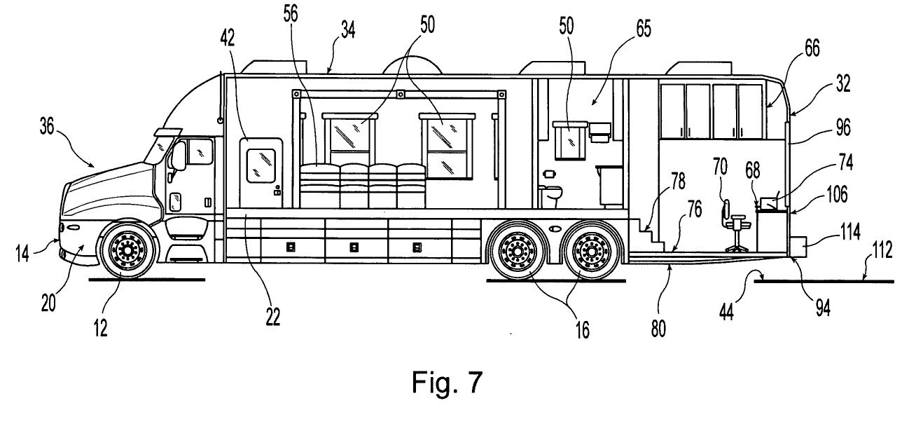

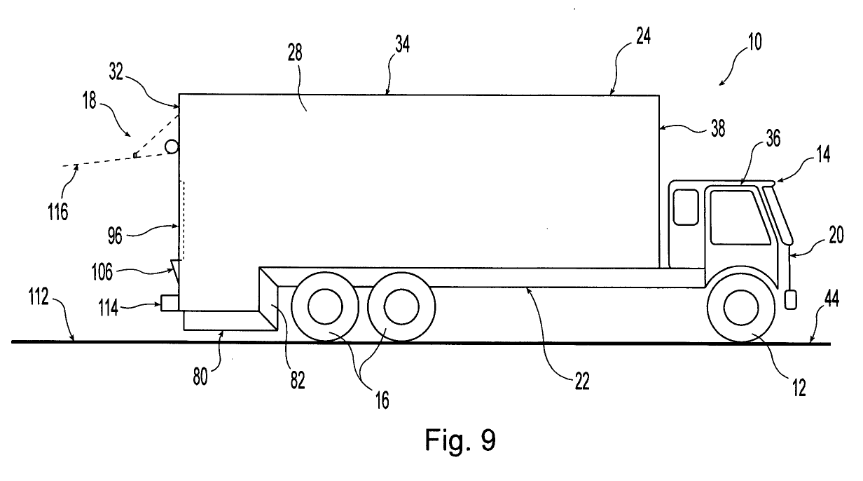

Mobile banking vehicle 10 includes a chassis 22, diagrammatically shown in FIGS. 7-9, which is supported by the front wheels 12 and rear wheels 16 with a suspension system (not shown) in a known and customary manner. Chassis 22 supports the office area enclosure 24 which is generally formed of a floor 26 (FIGS. 4-8), right side wall 28 (FIG. 1), left side wall 30 (FIG. 2), rear wall 32 (FIG. 3) and roof 34 (FIG. 3). Because the floor 26 is supported by the wheels, axles, suspension and chassis, it is typically at a height of about 25-61 inches from a ground surface 44, depending on the size of such components. A driving cab area 36 is provided at the front end 14 of vehicle 10 and can be separate from the office area enclosure 24 as shown in FIGS. 5 and 9 or, preferably, formed together with and for access from the office area enclosure as shown in FIG. 4. When the cab area 36 is separate from the enclosure 24, a front wall 38 forms the front of enclosure 24, whereas when cab area 36 is formed together with the enclosure 24 the cab functions as the front wall of the enclosure 24. In the embodiment of FIG. 4, a cab door 40 is provided through the front wall 38 between the cab area 36 and the office area enclosure 24.

An exterior entrance door 42 is provided through side wall 28 leading to within the office area enclosure 24. Because the height of floor 26 is set on chassis 22 and is higher than the ground surface 44, steps 46 are provided near the door 42 between the ground surface 44 and the floor 26. One or more of the steps can be retractable and are used by extending for use and retracting when vehicle 10 is in transport. Extending sections 48 can be provided for selectively extending the side walls 28, 30 outwardly and increasing the size of the office area enclosure 24 as best shown if FIGS. 4 and 5. Windows 50 are also provided in side walls 28, 30 for providing yet more comfort to bank personnel and customers within the office enclosure 24.

The interior of the office area enclosure 24 can be configured in different ways and two preferred configurations are shown in FIGS. 4 and 5. In FIG. 4, the office area generally includes a lobby area 52 with a reception desk 54 and seating 56; interior teller desks 58; kitchenette 60 with refrigerator 62 and sink 64; bathroom 65; and, lowered drive-up teller area 66 with teller counter 68, chairs 70, computer 72, printer 74 and other amenities as are normally needed for drive-up banking transactions. The office shown in FIG. 5 generally similarly includes a lobby area 52 with a reception desk 54, seating 56 and check stand 55; interior teller desk 58; kitchenette 60 with refrigerator 62 and sink 64; bathroom 65; and, lowered drive-up teller area 66 with teller counter 68, chair 70, computer 72, printer 74 and other amenities as are normally needed for drive-up banking transactions.

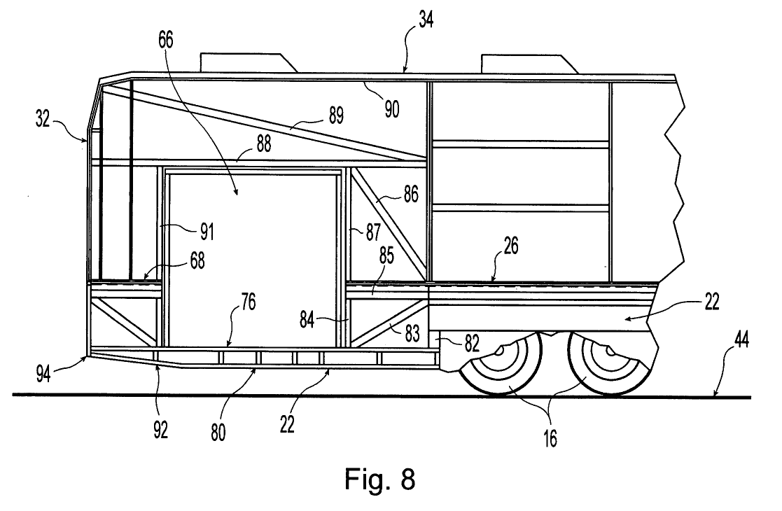

The chassis 22 of vehicle 10 has been modified so that the drive-up teller area floor 76 is lower than the rest of the office area enclosure floor 26, and interior steps 78 are provided between the lower teller area floor 76 and the lobby and other areas higher floor 26. More particularly, as best shown in FIGS. 8 and 9, the drive-up teller area 66 or portion of chassis 22 behind rear wheels 16 is dropped relative to the rest of the chassis and is formed with a plurality of beams 80 which are attached to the rest of the chassis 22 via reinforcing members 82, 83, 84 and 85. A truss structure is also formed within the side walls 28, 30 with truss members including members 86-91 as shown in FIG. 8 serving to rigidify and support the drive-up teller area 66.

Preferably, by lowering the drive-up teller area floor 76 in this manner, the minimum ground clearance or height of the bottom of beams 80 near rear wheels 16 is about 12 inches from the ground surface 44. Beams 80 are slopped upwardly at the terminal portion 92 so that the rear terminal end 94 minimum ground clearance or height is about 17 inches from the ground surface 44. Additionally, the drive-up teller area floor 76 is preferably about 17-21 inches above the ground surface 44, and the top surface of the teller counter 68 is preferably about 35-61 inches above the ground surface.

A teller window 96 is provided at the lowered drive-up teller area 66 preferably through the exterior rear wall 32, although it is contemplated it could also be placed in the side walls 28, at the lowered drive-up teller area 66. Teller window 96 includes bullet resistant glass 98 and, in light of the lowered drive-up floor 76, its bottom edge 100 is about 35-57 inches, and more preferably about 37-41 inches, above the ground surface 44. Accordingly, window 96 is at a comfortable and proper height for banking personnel or teller working at teller counter 68, and is also at a comfortable and proper height on the outside of the office enclosure 24 and relative to the ground surface 44 for drive-up banking.

The mobile banking vehicle 10 further includes an intercommunication system whereby verbal communication is selectively provided between the teller inside the enclosure 24 and the outside of the enclosure adjacent the teller window 96. The intercommunication system may be in the form of an opening through the window glass 98 and a steel insert 102 secured in the glass opening and having a plurality of slots wherethough communication is provided between the inside and the outside of the enclosure 24. More preferably, the intercommunication system is in the form of electronic intercom 104 including electronic microphones and speakers.

A transaction drawer 106 is provide preferably through the rear wall 32 below the teller window 96, so that financial documents can be selectively moved between the inside and the outside of the enclosure 24. As best seen in FIGS. 4 and 5, transaction drawer 106 is built into the teller counter 68 so that the opening into the drawer is flush with the counter 68 top or working surface. Preferably, the transaction drawer 106 includes a bottom drawer surface 108 located within about 25-52 inches, and more preferably about 25-29 inches, from a ground surface 44 for thereby placing the transaction drawer 106 at a comfortable and proper height for use by the customer outside and the teller inside the enclosure 24. As used herein, “transaction drawer” is intended to include an opening below the lowermost edge 100 of the teller window glass 98 wherethrough financial documents can be passed, or the preferred sliding drawer 106 shown in FIGS. 3-5 which includes a drawer door 110 which is coupled to and adapted to open and close with the drawer for providing access to the drawer by only one of the bank teller or customer at any time, or transaction drawers similar thereto for use in passing documents and things between the inside and outside of enclosure 24.

Because the teller window 98 and transaction drawer 106 are at a comfortable and proper height for drive-up banking, a customer vehicle drive-up ground surface lane or area 112 can and is provided outside of the enclosure 24 adjacent the rear wall 32, teller window 98 and transaction drawer 106. The drive-up area is at the ground surface 44 level and allows a banking customer to drive his vehicle next to the rear wall 32 for conducting his banking business. In this regard, the mobile banking vehicle 10 further includes a bumper 114 extending out from the rear wall 32 and below the teller window 98. The bumper 114 extends at least eight inches, and preferably 10-12 inches, away from the rear wall 32 and serves to help banking drive-up customers locate their vehicle at a proper distance from the rear wall 32 as they approach the drive-up area 112. It is noted that transaction drawer 106 is sized accordingly so that it may selectively be extended out from the rear wall 32, as shown in FIG. 3, a sufficient distance relative to the bumper 114 so that a banking customer may comfortably reach inside the drawer while in his vehicle and on the drive-up area 112. In an alternate embodiment, the bumper 114 is selectively extendable and retractable such as with a hydraulic system so that, while the banking vehicle is in use, the bumper is extended to about 12 inches away from rear wall 32, and while in transport it is retracted to about 6 inches away from the rear wall 32.

For yet additional comfort and utility, the banking vehicle 10 is provided with a canopy 116, shown in dash lines in FIG. 9, which is selectively extendable from the rear wall 32 substantially over the drive-up area 112 and the teller window 96 and transaction drawer 106. Accordingly, in the event of rain, a banking customer in his vehicle and on the drive-up area 112 can pass financial documents in and out of transaction drawer 106 without such documents getting wet.

An ATM interface 118 is also provided in sidewall 28 and is located at a height comfortably useable and proper for both drive-up and walk-up use by banking customers.

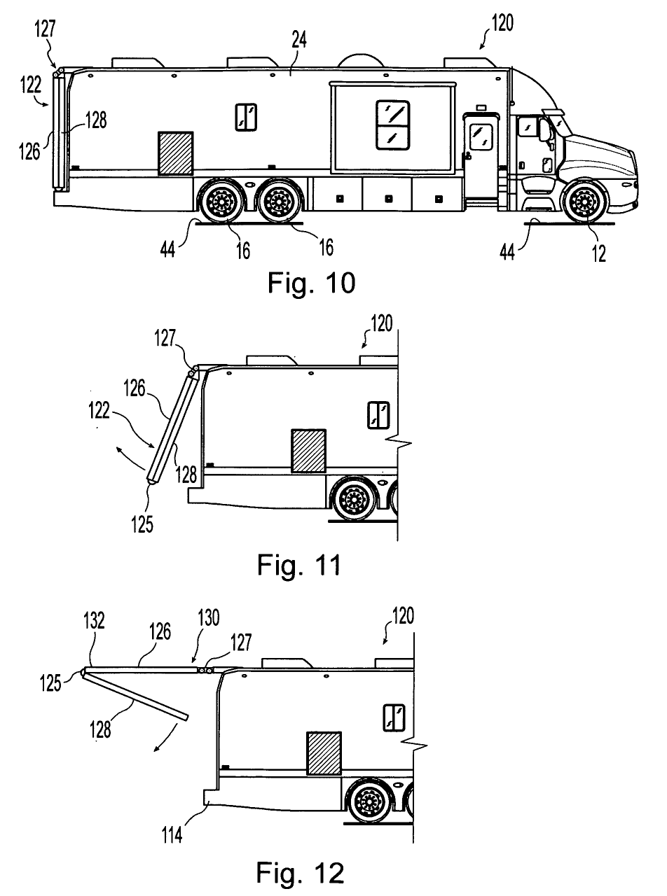

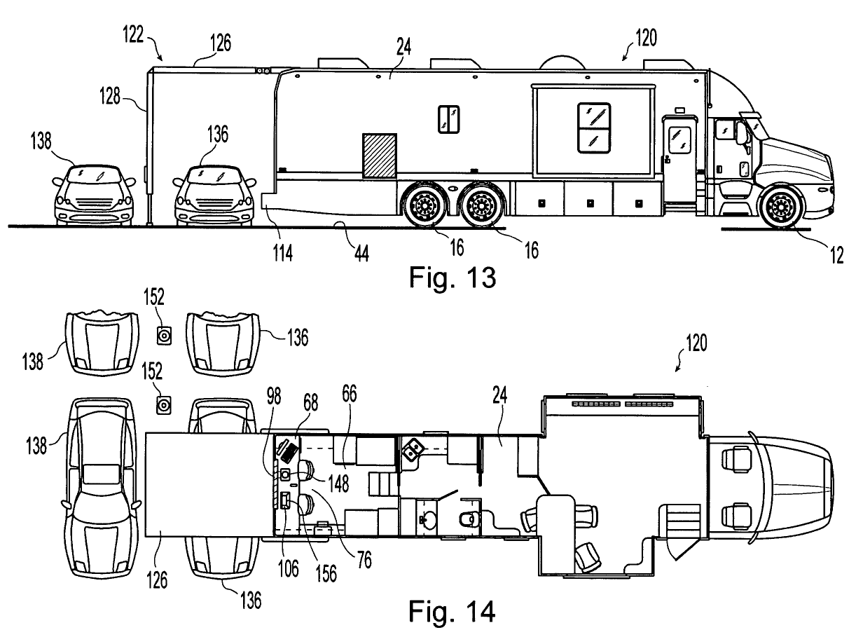

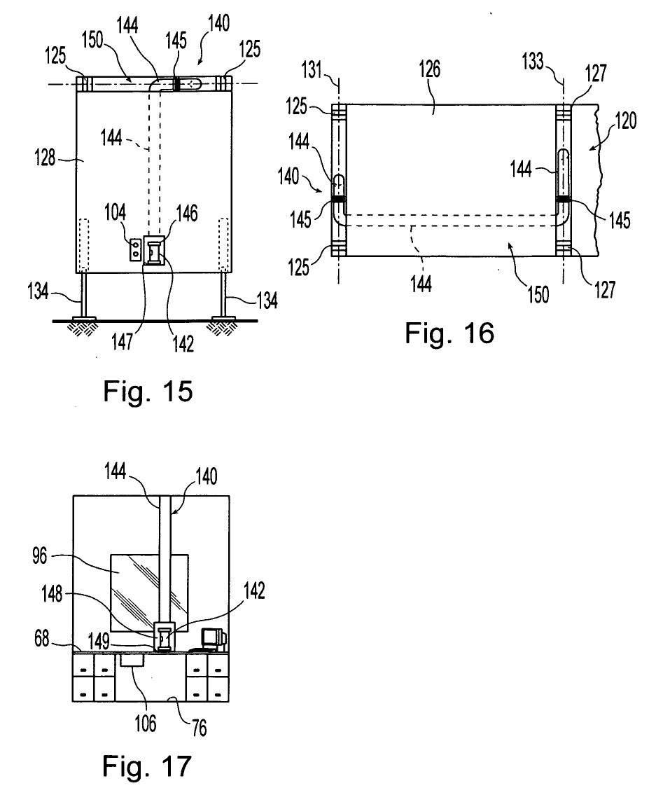

FIGS. 10-17 illustrate another embodiment of a mobile banking vehicle 120 in accordance with the present invention. Mobile banking vehicle 120 is similar to mobile banking vehicle 10 but further includes an extendable canopy 122 and a conveyance system 140. FIG. 10 illustrates canopy 122 and conveyance system 140 in a collapsed or mobile configuration. When canopy 122 and conveyance system 140 are in the mobile configuration of FIG. 10, vehicle 120 can be moved from one location to another. After vehicle 120 has been positioned at a desired location for conducting banking transactions, canopy 120 and conveyance system 140 can be deployed. FIGS. 11-13 show the progressive unfolding of canopy 122 and conveyance system 140 with FIG. 13 depicting canopy 122 and conveyance system 140 in a fully deployed and operable configuration.

As shown in FIGS. 10-13, the canopy assembly pivots about two axes and includes an upper canopy panel 126 and a side panel 128. Upper panel 126 is pivotally connected with vehicle 120 along edge 130 with pivotal joints 127. Upper panel 126 is pivotally connected with side panel 128 at its opposite edge 132 with pivotal joints 125. Pivotal connections 125 allow side panel 128 to pivot between a position adjacent upper panel 126 (FIGS. 10 and 11) and a position that is oriented at a perpendicular angle to upper panel 126 (FIG. 13). Pivotal connections 127 between upper canopy panel 126 and vehicle 120 allows upper panel 126 to be pivoted between a substantially vertical position (FIG. 10) and a substantially horizontal position (FIG. 13). In the illustrated embodiment, side panel 128 is pivoted to a position adjacent the lower surface of upper panel 126 when collapsing canopy 122. As a result, side panel 128 is trapped between upper panel 126 and the body of vehicle 120 when canopy 122 is placed in its mobile configuration.

When deploying canopy 122, upper panel 126 is pivoted upwardly into a substantially horizontal position and side panel 128 is pivoted away from upper panel 126 as schematically depicted in FIGS. 11 and 12. Side panel 128 includes two telescoping support legs 134 which are extended from side panel 128 to engage the ground surface 44 after pivoting upper panel 126 into a substantially horizontal orientation and side panel 128 into a substantially vertical orientation. Legs 134 support side panel 128 and thereby also support the distal edge 132 of upper panel 126 when canopy 122 is deployed.

Upper panel 126 has a length between opposing edges 130, 132 that positions side panel 128 at a distance from vehicle 120 that is sufficient to allow passenger vehicles 136 to travel underneath upper panel 126 for the purpose of conducting banking transactions. Positioning side panel 128 at least about 10 feet away from the enclosure 24 of vehicle 120 will provide an adequate lane width below upper panel 126 for most passenger vehicles 136. The lane is defined on one side of side panel 128 and by a bumper 114 (discussed above with reference to vehicle 10) opposite side panel 128.

Banking customers located within a first queue of passenger vehicles 136 passing underneath upper canopy panel 126 can conduct banking transactions with personnel located inside enclosure 24 while remaining in their respective vehicles 136. A transaction drawer 106 provides a conveyance system that allows financial documents to be passed between the banking customers in vehicles 136 and a teller located within enclosure 24. Transaction drawer 106 is discussed in greater detail above with reference to vehicle 10 and includes an external port 154 accessible from outside enclosure 24 and an internal port 156 accessible from inside enclosure 24. Financial documents passed through transaction drawer 106 are deposited and retrieved through ports 154, 156 during the course of conducting banking transactions.

Mobile banking vehicle 120 also includes another conveyance system 140 that allows a teller within enclosure 24 to conduct banking transactions with customers located in vehicles 138 which form a second queue that is spaced from enclosure 24. The illustrated conveyance system 140 is a pneumatically powered conveyance system having a removable carrier 142 that is transported from external port 146 to internal port 148 through pneumatic tubes 144 by air pressure. Financial documents may be transferred between customers located in vehicles 138 and a teller located in enclosure 24 by placing them in carrier 142 and conveying carrier 142 through tubes 144. While a single teller could service customers in both queues, the use of two tellers to service the two queues would enable the customers to be more quickly served.

While the illustrated conveyance system 140 is a pneumatically powered system, other types of conveyance systems may also be used to transport financial documents between a port within enclosure 24 and an external port located exterior to and spaced from enclosure 24. For example, captive carrier tape drive systems which are commonly employed at pharmacy drive-through lanes such as the conveyance system sold by E.F. Bavis & Associates, Inc. of Maineville, Ohio under the TransTrax® mark could be adapted for use with mobile banking vehicle 120.

The pneumatic conveyance system 140 is similar to conventional pneumatic systems used to convey financial documents at drive through lanes at static banking buildings with the exception that pneumatic conveyance system 140 includes two rotating slip joints 145 that have axes which are collinear with canopy folding axes 131 and 133. Slip joints 145 thereby allow conveyance system 140 to be folded together with upper panel 126 and side panels 128 such that the external portion 150 of system 140 that is located outside enclosure 24 is moveable between a mobile configuration (FIG. 10) wherein external portion 150 is disposed proximate enclosure 24 and a deployed configuration (FIGS. 13 and 14) wherein external portion 150 extends outwardly from enclosure 24.

As mentioned above, by positioning side panel 128 and external port 146 mounted therein at least about 10 feet outwardly from enclosure 24 in the deployed configuration, the first queue of cars 136 waiting to use transaction drawer 106 can pass between enclosure 24 and side panel 128 and the external port 146 mounted therein. In addition to providing support for external port 146, side panel 128 also provides guidance for customers when they align their vehicles in the two different queues 136, 138. Traffic cones 152 or other similar devices and markings such as temporary or permanent markings on ground surface 44 may also be used to guide the formation of the two separate queues 136, 138 aligned with the external ports 154, 146 of the two conveyance systems 106, 140.

Side panel 128 also provides a mounting location for an electronic intercom 104 that provides remote communication between a customer at external port 146 and a teller within enclosure 24. In some embodiments, side panel 128 may also include standard vehicle operation lights such as brake lights and turn signal lights so that when canopy 122 is in its mobile configuration, the vehicle operation lights on panel 128 will positioned for viewing by other vehicles in the traffic stream. Alternatively, the vehicle operation lights on the rear of vehicle 120 can be positioned so that they are visible when canopy assembly 122 is in its mobile configuration or temporary lights may be attached to the rear of vehicle 120. Moreover, in still other embodiments of the present invention, a collapsible skeletal framework could be used to support conveyance system 140 and intercom 104 instead of solid folding panels 126, 128.

The two conveyance systems of vehicle 120, i.e., transaction drawer 106 and pneumatic tube system 140, are positioned at heights that facilitate the use of the two conveyance systems by banking customers who are seated in passenger vehicles. For transaction drawer 106, positioning the bottom surface 108 of drawer 106 at a height of between approximately 25 and 52 inches and, more preferably, between approximately 25 inches and approximately 29 inches above ground surface 44 facilitates the use of transaction drawer 106 by customers located in passenger vehicles. Similarly, positioning the lower edge 147 of external port 146 at a height of approximately 25 inches to approximately 29 inches above ground surface 44 also facilitates the use of conveyance system 140 by customers located in passenger vehicles.

The enclosure floor 76 in the lowered teller area 66 proximate internal port 148 and transaction drawer 106 is advantageously positioned at a height of no more than about 21 inches above the ground surface 44 as discussed above with reference to vehicle 10 to thereby position the tellers within teller area 66 at a convenient height for conducting business with customers located in passenger vehicles 36, 38. The internal port 156 of transaction drawer 106 is flush with teller counter 68 and the lower edge 149 of internal port 148 of conveyance system 140 is located just above teller counter 68 positioning both of these internal ports 156, 148 at heights that are convenient for tellers located within enclosure 24.

Both of the conveyance systems 106, 140 are used to convey financial documents between the customer located outside enclosure 24 and the teller located within enclosure 24. The financial documents are associated with the banking transaction that is being conducted and may be provided by the teller to the customer, e.g., a document memorializing the banking transaction, or it may be a document provided by the customer to the teller, e.g., a check, or both the teller and the customer may transfer a financial document to the other individual in the course of conducting the banking transaction.

By positioning upper canopy panel 126 above transaction drawer 106, cars 136 in the first queue positioned adjacent transaction drawer 106 are positioned at least partially below upper canopy panel 126 thereby sheltering the financial documents from rain as the customer removes or deposits the documents in transaction drawer 106.

While a mobile banking vehicle having a single conveyance system, such as vehicle 10 having a single transaction drawer 106, can be used to provide drive-through banking services, a mobile banking vehicle having two conveyance systems will allow the personnel located within enclosure 24 to serve a higher volume of banking customers. By spacing the external port 148 of one of the two conveyance systems from the enclosure by at least about 10 feet from the vehicle enclosure 24, the formation of two queues of passenger vehicles is more easily accomplished.

As evident from the discussion presented above, the usefulness of a mobile banking vehicle 120 is enhanced by providing it with two conveyance systems wherein one of those conveyance systems has an external portion that extends outwardly from enclosure 24 to space its external port 146 away from enclosure when deployed and is repositionable into a mobile configuration where the external portion 150 is proximate enclosure 24. Such a vehicle can have the external portion 150 of its repositionable conveyance system placed in its mobile configuration and the vehicle 120 can be easily moved to a different location. Once the vehicle has been parked at the new location, the conveyance system 140 can be repositioned into its deployed or operable configuration (FIGS. 13 and 14). Once deployed, two queues of passenger vehicles 136, 138 can be allowed to form and personnel located within enclosure 24 can begin performing banking transactions with customers in the two queues utilizing both transaction drawer 106 and conveyance system 140 to transfer financial documents associated with those transactions.

While the invention has been described as having specific embodiments, it will be understood that it is capable of further modification. This application is, therefore, intended to cover any variations, uses, or adaptations of the invention following the general principles thereof and including such departures from the present disclosure as come within known or customary practice in the art to which this invention pertains and fall within the limits of the appended claims.

What is claimed is:

1. A mobile banking vehicle positionable on a ground surface, said vehicle comprising:
an enclosure having a floor, walls and roof, a door in one of said walls providing ingress and egress to said enclosure for personnel, and wheels supporting and providing mobility to said enclosure; and
a conveyance system having a first port and a second port and having an operable configuration wherein financial documents are selectively conveyable between said first and second ports with said first port being accessible from within said enclosure and said second port being accessible from a position exterior to and spaced from said enclosure.

2. The mobile banking vehicle of claim 1 wherein said conveyance system has an external portion disposed exterior to said enclosure, said external portion being moveable between a mobile configuration and a deployed configuration wherein all of said external portion is disposed proximate said enclosure in said mobile configuration thereby facilitating movement of said vehicle and wherein said external portion extends outwardly from said enclosure in said deployed configuration.

3. The mobile banking vehicle of claim 1 further comprising a canopy selectively extendable from said enclosure proximate said second port.

4. The mobile banking vehicle of claim 1 wherein said conveyance system is a pneumatically powered conveyance system.

5. The mobile banking vehicle of claim 4 further comprising a transaction drawer.

6. The mobile banking vehicle of claim 5 wherein said second port is positionable at a location spaced outwardly from said enclosure proximate said transaction drawer whereby a first queue of passenger vehicles waiting to use said transaction drawer can pass between said enclosure and said second port.

7. The mobile banking vehicle of claim 6 wherein said conveyance system has an external portion disposed exterior to said enclosure moveable between a mobile configuration and a deployed configuration wherein all of said external portion is disposed proximate said enclosure in said mobile configuration thereby facilitating movement of said vehicle and wherein said external portion extends outwardly from said enclosure in said deployed configuration.

8. The mobile banking vehicle of claim 7 wherein said pneumatically powered conveyance system comprises a first joint defining a first axis and a second joint defining a second axis, said pneumatically powered conveyance system being pivotal about said first and second axes when said external portion of said conveyance system is moved between said mobile and deployed configurations.

9. The mobile banking vehicle of claim 8 further comprising a canopy assembly selectively extendable from said enclosure wherein, when said canopy is extended, a passenger vehicle positioned adjacent said transaction drawer will be positioned at least partially below said canopy.

10. The mobile banking vehicle of claim 9 wherein said canopy assembly comprises a first panel and a second panel, said first panel being pivotally coupled with said mobile banking vehicle on one edge of said first panel wherein said first panel is rotatable relative to said mobile banking vehicle about an axis substantially co-linear with said first axis of said conveyance system; and said first panel being pivotally coupled with said second panel on an opposite edge of said first panel wherein said second panel is rotatable relative to said first panel about an axis substantially co-linear with said second axis of said conveyance system.

11. The mobile banking vehicle of claim 10 wherein said transaction drawer has a bottom surface and said second port has a lower edge which are both positioned at a height of between approximately 25 inches and approximately 29 inches above the ground surface; and wherein said enclosure floor is positioned at a height of no more than about 21 inches above the ground surface proximate said first port and said transaction drawer.

12. A mobile banking vehicle positionable on a ground surface, said vehicle comprising:
an enclosure having a floor, walls and roof, a door in one of said walls providing ingress and egress to said enclosure for personnel, and wheels supporting and providing mobility to said enclosure;
a first conveyance system having a first port and a repositionable second port wherein financial documents are selectively conveyable between said first and second ports when said first conveyance system is in a deployed configuration, said first port being accessible from within said enclosure and wherein, when said first conveyance system is in a deployed configuration, said second port is accessible from a position exterior to and spaced from said enclosure; and
a second conveyance system having a third port and a fourth port wherein financial documents are selectively conveyable between said third and fourth ports, said third port being accessible from within said enclosure and said fourth port being accessible from outside said enclosure.

13. The mobile banking vehicle of claim 12 wherein said first conveyance system is a pneumatically powered conveyance system and said second conveyance system is a transaction drawer.

14. The mobile banking vehicle of claim 13 wherein said first conveyance system has an external portion disposed exterior to said enclosure moveable between a mobile configuration and said deployed configuration wherein all of said external portion is disposed proximate said enclosure in said mobile configuration thereby facilitating movement of said vehicle; and wherein said vehicle further comprises a canopy selectively extendable from said enclosure wherein, when said canopy is extended, a passenger vehicle positioned adjacent said transaction drawer will be positioned at least partially below said canopy.

15. A method of conducting a banking transaction, said method comprising:
providing a mobile banking vehicle having an enclosure;
moving the mobile banking vehicle from a first location to a second location; and
conveying a financial document between a customer in a second vehicle located at the second location outside the enclosure and a teller located within the enclosure.

16. The method of claim 15 wherein the financial document is conveyed between the customer and the teller using a transaction drawer.

17. The method of claim 15 wherein the financial document is conveyed between the customer and the teller using a pneumatically powered conveyance system.

18. The method of claim 15 wherein the mobile banking vehicle includes a first conveyance system having a first port accessible from within the enclosure and a second port accessible from outside the enclosure and a second conveyance system having a third port accessible from within the enclosure and a fourth port accessible from a position exterior to and spaced from the enclosure and wherein said method further comprises:
forming a first queue of customer vehicles and conducting banking transactions, in turn, with the customers in the first queue utilizing the first conveyance system to transfer financial documents between the customers in the first queue and a teller located within the enclosure; and
forming a second queue of customer vehicles and conducting banking transactions, in turn, with the customers in the second queue utilizing the second conveyance system to transfer financial documents between the customers in the second queue and a teller located within the enclosure.

19. The method of claim 18 wherein the first conveyance system comprises a transaction drawer and the second conveyance system comprises a pneumatically powered conveyance system.

20. The method of claim 19 wherein the second conveyance system is moveable between a mobile configuration wherein an external portion of the second conveyance system is disposed exterior to the enclosure is disposed proximate the enclosure and a deployed configuration wherein the external portion of the second conveyance system extends outwardly from the enclosure and said method further comprises:
placing the second conveyance system in the mobile configuration when moving the mobile banking vehicle from the first location to the second location; and
placing the second conveyance system in the deployed configuration after moving the mobile banking vehicle to the second location and before forming the second queue of customer vehicles.
